(19) United States
(12) Patent Application Publication
(10) Pub. No.: US 2022/0289623 A1
(43) Pub. Date: Sep. 15, 2022

(54) ION EXCHANGE PROCESS FOR ULTRA-THIN GLASS

(71) Applicant: CORNING INCORPORATED, CORNING, NY (US)

(72) Inventors: Diane Kimberlie Guilfoyle, Painted Post, NY (US); Yuhui Jin, Painted Post, NY (US); Kuan-Ting Kuo, Horseheads, NY (US); Linda Frances Reynolds-Heffer, Horseheads, NY (US)

(21) Appl. No.: 17/637,648

(22) PCT Filed: Aug. 12, 2020
(86) PCT No.: PCT/US2020/045917

§ 371 Date: Feb. 23, 2022

Related U.S. Application Data
(60) Provisional application No. 62/893,296, filed on Aug. 29, 2019.

(51) Int. Cl. C03C 21/00; C03C 3/097

(52) U.S. Cl. CPC C03C 21/002; C03C 3/097

(57) ABSTRACT

A method of chemically strengthening a glass-based article via ion exchange, wherein the glass-based article has a thickness of less than about 300 mm. The glass-based article may be chemically strengthened by ion exchanged to achieve a depth of compression DOC ranging from about 5 mm to about 60 mm and a peak compressive stress in a range from about 300 MPa to about 2000 MPa. The high peak compressive stress provides the ability to withstand the stresses associated with bending and to resist damage caused by impact. Additionally, the glass-based article retains net compression to contain surface flaws when the glass is subjected to bending around a tight radius in use, for example, as cover glass in flexible and foldable displays.

### CROSS-REFERENCE TO RELATED APPLICATION

This application claims the benefit of priority under 35 U.S.C. § 119 of U.S. Provisional Application Ser. No. 62/893,296 filed on Aug. 29, 2019, the content of which is relied upon and incorporated herein by reference in its entirety.

### FIELD

The disclosure relates to glass-based articles having a thickness of 300 μm or less. More particularly, the disclosure relates to methods of chemically strengthening such glass-based articles. Even more particularly, the disclosure relates to methods of chemically strengthening glass-based articles that are used in applications such as flexible displays, wherein the glass is subject to significant bending stresses.

### TECHNICAL BACKGROUND

Glass glass-based articles used for displays in electronic devices such as cellular phones, smart phones, tablets, watches, video players, information terminal (IT) devices, laptop computers, and the like are typically chemically or thermally tempered to produce a surface compressive stress layer, which serves to arrest flaws that can cause failure of the glass. Chemical strengthening of the glass is often achieved by an ion exchange process in which the glass-based article is immersed in a molten salt bath containing ions (typically alkali metal ions). Cations in the bath replace smaller cations of equal charge that are present at or near the surface of the glass-based article, thereby producing the surface compressive stress layer described above. This traditional chemical strengthening process requires costly high temperature processing for several hours in the molten salt bath to achieve a sufficient depth of compression (DOC), which is typically 160 μm for 40 mm thick glass.

Foldable displays and hand-held devices for electronic applications benefit from thin (for example, having a thickness of less than about 300 μm) or ultra-thin (for example, having a thickness of less than about 125 μm, or less than about 100 μm, or less than 75 μm, or less than 50 μm, or about 25 μm, or about 20 μm) bendable, foldable glass-based articles. Such thin and ultra-thin glasses allow the device to be bent to tighter bend radii. In addition, it is desirable that these articles have sufficient strength to withstand the stresses associated with bending and resist damage caused by impact. Conventional ion exchange methods such as those described hereinabove tend to warp thin and ultra-thin glass-based articles. Moreover, such glass glass-based articles, due to their reduced thickness, require special handling to prevent breakage. Conventional ion exchange methods also result in deeper depths of compression than necessary in applications where thin and ultra-thin glass-based articles are used, thereby further increasing costs.

### SUMMARY

The present disclosure provides methods of chemically strengthening a glass-based article via ion exchange, wherein the glass-based article has a thickness of less than about 300 μm and, in some embodiments, less than about 125 μm, or less than about 100 μm, or less than 75 μm, or less than 50 μm, or about 25 μm, or about 20 μm. The glasses described herein may be ion exchanged to achieve a depth of compression DOC ranging from about 5 μm to about 60 μm. The compressive stress layer has a peak compressive stress in a range from about 300 MPa to about 2000 MPa. The high peak compressive stress provides the ability to withstand stresses associated with bending and resist damage caused by impact. The high peak compressive stress allows the glass to retain net compression and thus contain surface flaws when the glass is subjected to bending around a tight radius during use, for example, as a cover glass in flexible and foldable displays. The high peak compressive stress also assists in preventing fracture from applied stresses (e.g., bending the glass) for a given flaw population, which may be introduced during processing of the glass and/or during use thereof in a device. High fracture toughness also assists in preventing fracture from applied stresses (e.g. from bending) for a given flaw population that may be introduced during processing of the glass and/or during use thereof in a device.

Accordingly, some embodiments of the disclosure provide methods of chemically strengthening a glass-based article. Some methods comprise applying an aqueous precursor solution to a surface of the glass-based article to form a film-forming coating on the surface at room temperature. The aqueous precursor solution comprises an organic binder, a first alkali metal salt comprising a plurality of first alkali metal cations, and a second alkali metal salt comprising a plurality of second alkali metal cations. The film-forming coating comprises the organic binder and the first alkali metal salt and the second alkali metal salt. The organic binder is removed from the film-forming coating to form a coating comprising the first alkali metal salt and the second alkali metal salt in solid form. The coating is heated at a temperature that is above the melting point of the first alkali metal to form a melt comprising the first alkali cations while the second alkali metal salt remains in solid form. The glass-based article and the coating are heated at a temperature in a first range from about 350° C. to about 500° C., or from about 380° C. to about 420° C., or from about 390° C. to about 410° C., wherein the first alkali metal cations in the melt replace a plurality of third alkali metal cations in the glass-based article to form an ion exchanged glass-based article. The ion exchanged glass-based article has a compressive stress layer extending from the surface of the glass-based article to a depth of compression DOC, which is in a range from about 5 μm to about 60 μm.

Some embodiments of the disclosure provide a chemically strengthened bendable glass-based article with a thickness in a range from about 20 μm to about 300 μm, for example, from 20 μm to about 275 μm, or from 20 μm to about 250 μm, or from 20 μm to about 225 μm, or from 20 μm to about 200 μm, or from 20 μm to about 175 μm, or from 20 μm to about 150 μm, or from 20 μm to about 125 μm, or from 20 μm to about 100 μμm, or from 20 μm to about 75 μm, or from 20 μm to about 50 μm, or from 30 μm to about 300 μm, or from 40 μm to about 300 μm, or from 50 μm to about 300 μm, or from 75 μm to about 300 μm, or from 100 μm to about 300 μm, or from 125 μm to about 300 μm, or from 150 μm to about 300 μm, or from 175 μm to about 300 μm, or from 200 μm to about 300 μm, or from 250 μm to about 300 μm, or from 275 μm to about 300 μm, or from 40 μm to about 275 μm, or from 50 μm to about 250 μm, or from 75 μm to about 225 μm, or from 100 μm to about 200 μm, or from 125 μm to about 175 μm. The chemically strengthened bendable glass-based article comprises an alkali aluminosilicate glass, an alkali aluminoborosilicate glass, an alkali borosilicate glass, or a soda lime glass. The chemically strengthened bendable glass-based article comprises a layer under a compressive stress (compressive stress layer), the layer extending from a surface of the chemically strengthened bendable glass-based article to a DOC. The DOC is in a range from about 5 μm to about 60 μm, and comprises a maximum compressive stress in a range from about 300 MPa to about 2000 MPa.

Various features of the disclosure may be combined in any and all combinations and, for example, according to the various following embodiments.

Embodiment 1. A method of chemically strengthening a glass-based article, the method comprising:
a. applying an aqueous precursor solution comprising an organic binder, a first alkali metal salt comprising a plurality of first alkali metal cations, and a second alkali metal salt comprising a plurality of second alkali metal cations to a surface of the glass-based article to form a film-forming coating on the surface, the film-forming coating comprising the organic binder, the first alkali metal salt, and the second alkali metal salt, wherein the aqueous precursor solution is applied to the surface at room temperature;
b. removing the organic binder from the film-forming coating to form a coating comprising the first alkali metal salt and the second alkali metal salt in solid form; and
c. heating the glass-based article and the coating at a temperature in a first range from about 350° C. to about 500° C. after removing the organic binder, wherein the first alkali metal salt forms a melt, and wherein the first alkali metal cations in the melt replace a plurality of third alkali metal cations in the glass-based article to form an ion exchanged glass-based article, the ion exchanged glass-based article comprising a compressive stress layer extending from the surface of the glass-based article to a depth of compression in a range from about 5 μm to about 60 μm.

Embodiment 2. The method of Embodiment 1, wherein the thickness of the glass-based article before and after ion exchange is in a range from about 20 μm to about 300 μm.

Embodiment 3. The method of Embodiment 2, wherein the thickness of the glass-based article before and after ion exchange is in a range from about 20 μm to about 125 μm.

Embodiment 4. The method of any one of Embodiments 1-3, wherein the compressive stress layer comprises a maximum compressive stress in a range from about 300 MPa to about 2000 MPa.

Embodiment 5. The method of any one of Embodiments 1-4, wherein the compressive stress layer comprises a maximum compressive stress in a range from about 600 MPa to about 900 MPa.

Embodiment 6. The method of any one of Embodiments 1-5, wherein each of the first alkali salt and the second alkali salt comprises one or more of a nitrate, sulfate, phosphate, carbonate, or halide of the first alkali metal and or the second alkali metal.

Embodiment 7. The method of any one of Embodiments 1-6, wherein the first alkali cation and the second alkali cation are the same.

Embodiment 8. The method of Embodiment 7, wherein the first alkali metal salt is KNO₃ and the second alkali metal salt is K₃PO₄.

Embodiment 9. The method of any one of Embodiments 1-8, wherein the third alkali metal cation is Li⁺, Na⁺, or combinations thereof.

Embodiment 10. The method of any one of Embodiments 1-9, wherein the first alkali cation has a first ionic radius and the third alkali metal cation has a third ionic radius, and wherein the first ionic radius is greater than the third ionic radius.

Embodiment 11. The method of any one of Embodiments 1-10, wherein the glass-based article comprises an alkali aluminosilicate glass, an alkali aluminoborosilicate glass, an alkali borosilicate glass, or a soda lime glass.

Embodiment 12. The method of any one of Embodiments 1-11, wherein the alkali aluminosilicate glass or the alkali aluminoborosilicate glass comprises one of:
a. from about 50 mol % to about 72 mol % SiO₂; from about 9 mol % to about 17 mol % Al₂O₃; from about 2 mol % to about 12 mol % B₂O₃; from about 8 mol % to about 16 mol % Na₂O; and from 0 mol % to about 4 mol % K₂O, wherein the ratio [Al₂O₃(mol %)+B₂O₃(mol %)/Σmodifiers(mol %)]>1, where the modifiers are selected from the group consisting of alkali metal oxides and alkaline earth metal oxides; or
b. from about 61 mol % to about 75 mol % SiO₂; from about 7 mol % to about 15 mol % Al₂O₃; from 0 mol % to about 12 mol % B₂O₃; from about 9 mol % to about 21 mol % Na₂O; from 0 mol % to about 4 mol % K₂O; from 0 mol % to about 7 mol % MgO; and from 0 mol % to about 3 mol % CaO; or
c. about 58 mol % or more SiO₂; from about 0.5 mol % to about 3 mol % P₂O₅; about 11 mol % or more Al₂O₃; Na₂O; and Li₂O, wherein the molar ratio (Li₂O/Na₂O) is less than 1.0, and wherein the alkali aluminosilicate glass is free of B₂O₃; or
d. from about 60 mol % to about 70 mol % SiO₂; from about 10 mol % to about 16 mol % Al₂O₃; from about 2 mol % to about 10 mol % Li₂O; from about 8 mol % to about 13 mol % Na₂O; from greater than 0 mol % to about 6 mol % MgO; and from about 2 mol % to about 6 mol % ZnO; or
e. about 17 or more mol % Al₂O₃ and non-zero amounts of Na₂O, MgO, and CaO, wherein Al₂O₃(mol %)+RO(mol %)≥21 mol %, where RO(mol %)=MgO(mol %)+CaO(mol %)+ZnO(mol %), wherein the alkali aluminosilicate glass is substantially free of each of SrO, BaO, B₂O₃, P₂O₅, and K₂O.

Embodiment 13. The method of any one of Embodiments 1-12, wherein the step of applying the aqueous precursor solution to the surface of the glass-based article to form the film-forming coating comprises one or more of spraying the aqueous precursor solution onto the surface, dipping the glass-based article in the aqueous precursor solution, or casting the aqueous precursor solution on the surface.

Embodiment 14. The method of any one of Embodiments 1-13, wherein the step of removing the organic binder comprises heating the glass-based article and the film-forming coating at a temperature in a second range from about 300° to about 500° C.

Embodiment 15. The method of any one of Embodiments 1-14, wherein the step of heating the glass-based article and the coating at a temperature in the first range from about 350° C. to about 500° C. comprises heating the glass-based article and the coating at the temperature for a time period in a range from about 10 minutes to about 20 minutes.

Embodiment 16. The method of any one of Embodiments 1-15, wherein the first range is from about 390° C. to about 410° C.

Embodiment 17. The method of any one of Embodiments 1-16, wherein the thickness of the ion exchanged glass-based article is in a range from about 100 micrometers (μm, or microns) to about 35 μm and wherein the ion exchanged glass-based article comprises a minimum bend radius in a range from about 3 mm to about 6 mm, or more preferably in a range from about 3 mm to about 5 mm.

Embodiment 18. The method of any one of Embodiments 1-17, wherein the organic binder comprises one or more of a surfactant, a rheological modifier, or combinations thereof.

Embodiment 19. The method of any one of Embodiments 1-18, wherein the organic binder comprises one or more of cellulose, a cellulose derivative, a hydrophobically modified ethylene oxide urethane modifier, ethylene acrylic acid, or combinations thereof.

Embodiment 20. A chemically strengthened bendable glass-based article comprising: a thickness in a range from about 20 μm to about 300 μm; an alkali aluminosilicate glass, an alkali aluminoborosilicate glass, an alkali borosilicate glass, or a soda lime glass; a compressive stress layer extending from a first surface of the article to a depth of compression, wherein the depth of compression is in a range from about 5 μm to about 60 μm, and wherein the compressive stress layer comprises a maximum compressive stress in a range from about 300 MPa to about 2000 MPa.

Embodiment 21. The chemically strengthened bendable glass-based article of Embodiment 20, wherein the compressive stress layer comprises a maximum compressive stress in a range from about 600 MPa to about 900 MPa.

Embodiment 22. The chemically strengthened bendable glass-based article of Embodiment 20 or Embodiment 21, wherein the depth of compression is in a range from about 5 μm to about 10 μm.

Embodiment 23. The chemically strengthened bendable glass-based article of any one of Embodiments 20-22, wherein the alkali aluminoborosilicate or alkali aluminosilicate glass comprises one of:
a. from about 50 mol % to about 72 mol % SiO₂; from about 9 mol % to about 17 mol % Al₂O₃; from about 2 mol % to about 12 mol % B₂O₃; from about 8 mol % to about 16 mol % Na₂O; and from 0 mol % to about 4 mol % K₂O, wherein the ratio [Al₂O₃(mol %)+B₂O₃(mol %)/Σmodifiers(mol %)]>1, where the modifiers are selected from the group consisting of alkali metal oxides and alkaline earth metal oxides; or
b. from about 61 mol % to about 75 mol % SiO₂; from about 7 mol % to about 15 mol % Al₂O₃; from 0 mol % to about 12 mol % B₂O₃; from about 9 mol % to about 21 mol % Na₂O; from 0 mol % to about 4 mol % K₂O; from 0 mol % to about 7 mol % MgO; and from 0 mol % to about 3 mol % CaO; or
c. about 58 mol % or more SiO₂; from about 0.5 mol % to about 3 mol % P₂O₅; about 11 mol % or more Al₂O₃; Na₂O; and Li₂O, wherein the molar ratio (Li₂O/Na₂O) is less than 1.0, and wherein the alkali aluminosilicate glass article is free of B₂O₃; or
d. from about 60 mol % to about 70 mol % SiO₂; from about 10 mol % to about 16 mol % Al₂O₃; from about 2 mol % to about 10 mol % Li₂O; from about 8 mol % to about 13 mol % Na₂O; from greater than 0 mol % to about 6 mol % MgO; and from about 2 mol % to about 6 mol % ZnO; or
e. about 17 or more mol % Al₂O₃ and non-zero amounts of Na₂O, MgO, and CaO, wherein Al₂O₃(mol %)+RO(mol %)≥21 mol %, where RO(mol %)=MgO(mol %)+CaO(mol %)+ZnO(mol %), wherein the alkali aluminosilicate glass is substantially free of each SrO, BaO, B₂O₃, P₂O₅, and K₂O.

Embodiment 24. The chemically strengthened bendable glass-based article of any one of Embodiments 21-23, wherein the thickness of the ion exchanged glass-based article is in a range from about 100 μm to about 35 μm and wherein the ion exchanged glass-based article comprises a minimum bend radius in a range from about 3 mm to about 6 mm or more preferably 3 mm to about 5 mm.

Embodiment 25. The chemically strengthened bendable glass-based article of any one of Embodiments 20-24, wherein the thickness of the chemically strengthened bendable glass-based article is in a range from about 20 μm to about 125 μm.

Embodiment 26. The chemically strengthened bendable glass-based article of any one of Embodiments 20-25, wherein the chemically strengthened bendable glass-based article forms at least a portion of a flexible display.

Embodiment 27. The chemically strengthened bendable glass-based article of any one of Embodiments 20-26, wherein the chemically strengthened bendable glass-based article forms one or more of a cover glass at or over a display of an electronic device or a portion of a housing of the electronic device.

Embodiment 28. An electronic device comprising the chemically strengthened bendable glass-based article of any one of Embodiments 20-26, the electronic device comprising a housing comprising front, back, and side surfaces, electrical components which are at least partially internal to the housing, a display at or adjacent to the front surface of the housing, and a cover glass over the display, wherein one or more of the cover glass or the housing comprise the chemically strengthened bendable glass-based article, wherein the cover glass is at or over the front surface of the housing such that the cover glass is positioned over the display and protects the display from damage caused by impact.

These and other embodiments, advantages, and salient features will become apparent from the following detailed description, the accompanying drawings, and the appended claims.

### BRIEF DESCRIPTION OF THE DRAWINGS

FIG. 1 is a flow chart outlining a method of chemically strengthening a glass-based article according to some embodiments;

FIG. 1A is a schematic representation of a continuous process for practicing the method shown in FIG. 1;

FIG. 2 is a schematic cross-sectional view of a glass-based article with a film-forming layer deposited on one surface;

FIG. 3 is a schematic cross-sectional view of a chemically strengthened bendable glass-based article according to some embodiments;

FIG. 4 is a schematic cross-sectional view of a chemically strengthened bendable glass-based article under a bend-induced stress;

FIG. 5A is a plan view of an electronic device that incorporates any of the chemically strengthened bendable glass-based articles described herein; and

FIG. 5B is a side view of the exemplary electronic device of FIG. 5A.

### DETAILED DESCRIPTION

In the following description, like reference characters designate like or corresponding parts throughout the several views shown in the figures. It is also understood that, unless otherwise specified, the terms such as “top,” “bottom,” “outward,” “inward,” “right,” “left,” “front,” “back,” and the like are words of convenience and are not to be construed as limiting terms or to imply absolute orientation. In addition, whenever a group is described as comprising at least one of or one or more of a group of elements and combinations thereof, it is understood that the group may comprise, consist essentially of, or consist of any number of those elements recited, either individually or in combination with each other. Similarly, whenever a group is described as consisting of at least one of or one or more of a group of elements or combinations thereof, it is understood that the group may consist of any number of those elements recited, either individually or in combination with each other. Unless otherwise specified, a range of values, when recited, includes both the upper and lower limits of the range as well as any ranges therebetween. As used herein, the indefinite articles “a,” “an,” and the corresponding definite article “the” mean “at least one” or “one or more,” unless otherwise specified. It also is understood that the various features disclosed in the specification and the drawings can be used in any and all combinations with each other.

As used herein, the terms “glass-based article” and “glass-based articles” are used in their broadest sense to include any object made wholly or partly of glass, including glass, glass-ceramics, and sapphire. “Glass-ceramics” include materials produced through controlled crystallization of glass. In some embodiments, glass-ceramics have about 1% to about 99% crystallinity. Examples of suitable glass-ceramics may include Li₂O—Al₂O₃—SiO₂ system (for example, LAS-System) glass-ceramics, MgO—Al₂O₃—SiO₂ system (for example, MAS-System) glass-ceramics, ZnO×Al₂O₃×nSiO₂ (for example, ZAS system), and/or glass-ceramics that include a predominant crystal phase including β-quartz solid solutions, β-spodumene, cordierite, and lithium disilicate. The glass-ceramic substrates may be strengthened using the chemical strengthening processes disclosed herein. In one or more embodiments, MAS-System glass-ceramic substrates may be strengthened with Li₂SO₄ salt, whereby an exchange of 2Li⁺ for Mg²⁺ can occur. Unless otherwise specified, all glass compositions are expressed in terms of mole percent (mol %). The compositions of all molten salt baths—as well as any other ion exchange media—that are used for ion exchange are expressed in weight percent (wt %). Compositions of liquid solutions other than molten salt baths are also expressed in terms of weight percent.

As used herein, the term “liquidus temperature,” or “T^{L}” refers to the temperature at which crystals first appear as a molten glass cools down from the melting temperature, or the temperature at which the very last crystals melt away as temperature is increased from room temperature. As used herein, the term “165 kP temperature” or “T^{165 kP}” refers to the temperature at which the glass or glass melt has a viscosity of 160,000 Poise (P), or 160 kiloPoise (kP). As used herein, the term “35 kP temperature” or “T^{35 kP}” refers to the temperature at which the glass or glass melt has a viscosity of 35,000 Poise (P), or 35 kiloPoise (kP). The liquidus viscosity is determined by the following method. The liquidus temperature of the glass is first measured in accordance with ASTM C829-81 (2015), titled “Standard Practice for Measurement of Liquidus Temperature of Glass by the Gradient Furnace Method.” The viscosity of the glass at the liquidus temperature is then measured in accordance with ASTM C965-96 (2012), titled “Standard Practice for Measuring Viscosity of Glass Above the Softening Point.”

It is noted that the terms “substantially” and “about” may be used herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue. Thus, a glass that is “free of B₂O₃” or “substantially free of B₂O₃,” for example, is one in which B₂O₃ is not actively added or batched into the glass, but may be present in very small amounts as a contaminant.

In addition, the terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, or within about 5% of each other, or within about 2% of each other.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error, and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the endpoints of each of the ranges are significant both in relation to the other endpoint, and independent of the other endpoint.

As used herein, “peak compressive stress” refers to the highest compressive stress value measured within a region that is under compressive stress (compressive stress layer): a region of a solid material, for example, such as that extending from a surface of the material to a depth beneath the surface, that is under compressive stress. In some embodiments, the peak compressive stress is located at the surface of the glass. In other embodiments, the peak compressive stress may occur at a depth below the surface, giving the compressive stress profile the appearance of a “buried peak.” Compressive stress (including surface CS) is measured by a surface stress meter (FSM) using commercially available instruments, for example, the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured according to Procedure C (Glass Disc Method) described in ASTM standard C770-16, entitled “Standard Test Method for Measurement of Glass Stress-Optical Coefficient,” the contents of which are incorporated herein by reference in their entirety. As used herein, DOC means the depth at which the stress in the chemically strengthened glass-based articles described herein changes from compressive stress to tensile stress. DOC may be measured by FSM or a scattered light polariscope (SCALP) depending on the ion exchange treatment. Where the stress in the glass article is generated by exchanging potassium ions into the glass article, FSM is used to measure DOC. Where the stress is generated by exchanging sodium ions into the glass article, SCALP is used to measure DOC. Where the stress in the glass article is generated by exchanging both potassium and sodium ions into the glass, the DOC is measured by SCALP, since it is believed the exchange depth of sodium indicates the DOC and the exchange depth of potassium ions indicates a change in the magnitude of the compressive stress (but not the change in stress from compressive to tensile); the exchange depth of potassium ions in such glass articles is measured by FSM. Refracted near-field (RNF) method or SCALP may be used to measure the stress profile. When the RNF method is utilized to measure the stress profile, the maximum CT value provided by SCALP is utilized in the RNF method. In particular, the stress profile measured by RNF is force balanced and calibrated to the maximum CT value provided by a SCALP measurement. The RNF method is described in U.S. Pat. No. 8,854,623, entitled “Systems and Methods for Measuring a Profile Characteristic of a Glass Sample”, which is incorporated herein by reference in its entirety. In particular, the RNF method includes placing the glass article adjacent to a reference block, generating a polarization-switched light beam that is switched between orthogonal polarizations at a rate of between 1 Hz and 50 Hz, measuring an amount of power in the polarization-switched light beam and generating a polarization-switched reference signal, wherein the measured amounts of power in each of the orthogonal polarizations are within 50% of each other. The method further includes transmitting the polarization-switched light beam through the glass sample and reference block for different depths into the glass sample, then relaying the transmitted polarization-switched light beam to a signal photodetector using a relay optical system, with the signal photodetector generating a polarization-switched detector signal. The method also includes dividing the detector signal by the reference signal to form a normalized detector signal and determining the profile characteristic of the glass sample from the normalized detector signal. The RNF profile is then smoothed. As noted above, the FSM technique is used to determine the surface CS and slope of the stress profile in the CS region near the surface.

As used herein, “foldable” includes complete folding, partial folding, bending, flexing, or multiple capabilities.

As used herein, “minimum bend radius” is the minimum radius to which a glass-based article can be bent without failure, breaking, or otherwise damaging the sheet. The bend radius refers to the elliptical radius that is measured to the inside curvature of a bent glass-based article. As used herein, the terms “fail,” “failure” and the like refer to breakage, destruction, delamination, crack propagation or other mechanisms that render the stack assemblies, glass articles, and/or glass elements of this disclosure unsuitable for their intended purpose. A glass-based article achieves a bend radius of “X,” or has a bend radius of “X,” or comprises a bend radius of “X” if it resists failure when glass-based article is held at “X” radius for at least 24 hours at about 85° C. and about 85% relative humidity.

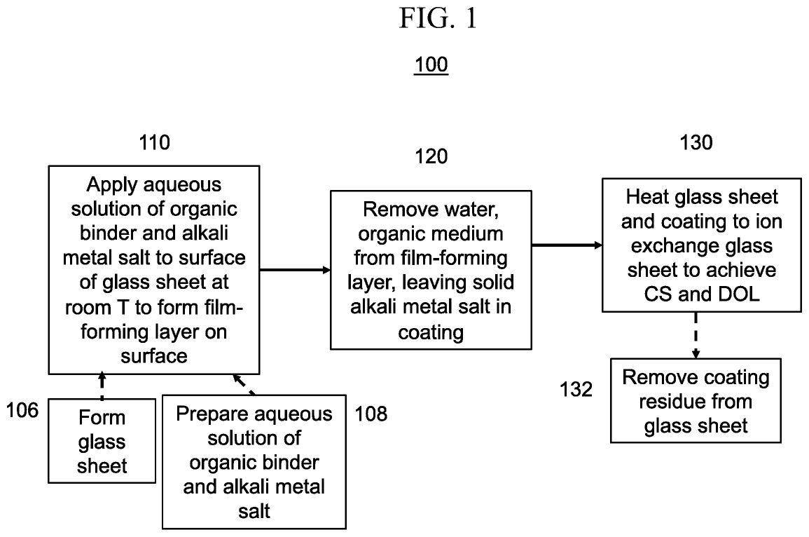

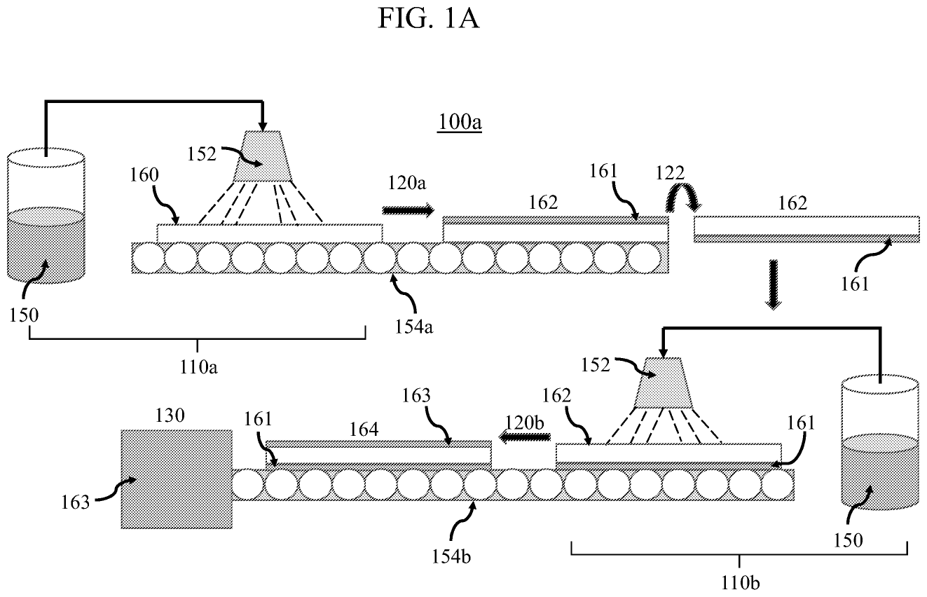

Referring to the drawings in general and to FIG. 1 in particular, it will be understood that the illustrations are for the purpose of describing particular embodiments and are not intended to limit the disclosure or appended claims thereto. The drawings are not necessarily to scale, and certain features and certain views of the drawings may be shown exaggerated in scale or in schematic in the interest of clarity and conciseness.

Described herein are methods of chemically strengthening a glass-based article by an ion exchange process. In this process, an aqueous precursor solution comprising a first alkali metal salt and a second alkali metal salt (sometimes referred to hereinafter as “first and second alkali metal salts”) is applied to a surface of a glass-based article as a film-forming coating. The first alkali metal salt comprises a first alkali cation (e.g., Na⁺, K⁺, Rb⁺) and the second alkali metal salt comprises a second alkali cation (e.g., Na⁺, K⁺, Rb⁺). In some embodiments, the first and second alkali metal salts comprise the same alkali cation (e.g., K⁺). The film-forming coating is then dried to remove water and heated to remove any binders, leaving behind a solid coating comprising the first alkali metal salt and the second alkali metal salt in solid form. The resulting coating and glass-based article are then heated to melt the first alkali metal salt and thereby effect ion exchange between the first alkali cations in the melt with third alkali cations within the glass-based article at or near the surface of the glass, wherein the third alkali cations differ from the first alkali cations.

A flow chart for the strengthening methods is shown in FIG. 1. In some embodiments, the strengthening method 100 further includes preparing an aqueous precursor solution comprising a first alkali metal salt, a second alkali metal salt, and at least one organic binder (step 108). The at least one organic binder may, in some embodiments, comprise a surfactant, a rheology modifier, or combinations thereof. The first and second alkali metal salts in the aqueous precursor solution include, but are not limited to, nitrates, sulfates, phosphates, halides (e.g., fluorides, chlorides, bromides, and iodides) of the alkali metals Na, K, Rb, and Cs. In some embodiments, the first and second alkali metal salts are selected from the group consisting of MNO₃, M₂CO₃, MOH, M₂SO₄, MF, M₃PO₄, M₂SiO₃, M₂Cr₂O₇, MCI, MBF₄, M₃HPO₄, or combinations thereof, where M is one or more of Na, K, Rb, Cs, or combinations thereof. In certain embodiments, the first alkali metal salt is potassium nitrate (KNO₃) and the second alkali metal salt is potassium phosphate (K₃PO₄).

The organic binder is water-soluble and serves to facilitate application of the aqueous precursor solution and ensure that the surface of the glass-based article is covered with a desired amount of the aqueous precursor solution. The viscosity of the aqueous precursor solution should be compatible with the method of application (e.g., spraying, dipping, casting, etc.) of the solution to the surface of the glass-based article. At the same time, the aqueous precursor solution should beneficially be sufficiently viscous to cover the glass surface with the desired amount of solution and establish contact between the solid first and second alkali metal salts in the film-forming layer and the glass surface. If the organic binder does not provide adequate viscosity, the aqueous precursor solution will not adhere to the glass surface and/or the resulting film-forming layer will not be continuous. If the aqueous precursor solution contains too much organic binder, the binder will coat the glass surface and block contact between the alkali metal salts and the glass surface. Possible organic binders include, but are not limited to: cellulose and cellulose derivatives, for example, but not limited to, ethyl cellulose, methyl cellulose; HUER (hydrophobically modified ethylene oxide urethane modifiers), AQUAZOL® (poly 2 ethyl-2 oxazine), preferably AQUAZOL® 5 or AQUAZOL® 50; EAA (ethylene acrylic acid); combinations thereof; and the like.

Alkali metal salts tend to form highly alkaline solutions. In one non-limiting example, the aqueous precursor solution comprises 25% potassium salts by weight, wherein the alkali metal salts consist of 90 mol % K₃PO₄ and 10 mol % KNO₃, and has a pH of about 14. With the exception of EAA, many of the organic binders described hereinabove are not effective in such highly alkaline solutions. In the particular instance described above, the aqueous precursor solution comprises about 1.2% to about 1.4% EAA by weight. However, the aqueous precursor solution may, in some embodiments, comprise up to about 5% EAA by weight. In some embodiments, solutions containing the first and second alkali metal salts and the organic binder are separately prepared and later combined before being applied to a surface of the glass-based article.

In step 110 of strengthening method 100, an aqueous precursor solution comprising an organic binder and the first and second alkali metal salts is applied to at least one surface of the glass-based article to form a film-forming layer on the surface. Step 110 is carried out at room temperature; for example, both the aqueous precursor solution and glass-based article are at a temperature in a range from about 20° C. to about 30° C., in some embodiments from about 20° C. to about 40° C., in some embodiments from about 20° C. to about 50° C., and in still other embodiments from about 20° C. to less than about 100° C.

The composition of the aqueous precursor solution is “tunable”—for example, the viscosity and evaporation rate of the solution are adjustable to achieve a continuous thin film deposition on the surface of the glass-based article in which solid alkali metal salt particles are retained on the surface of the glass-based article. In some embodiments, the viscosity of the aqueous precursor solution is less than or equal to about 50 centipoise (cps) and in other embodiments, in a range from about 0.2 cps, or from about 5 cps, or from about 10 cps, or from about 20 cps to about 30 cps, or up to about 40 cps, or up to about 50 cps. The evaporation rate of water, when referenced to n-butyl acetate (BuAc) is typically about 0.5. The aqueous precursor solution may be applied to the surface of the glass-based article by those means known in the art for example, but not limited to, spraying, slot-die coating, screen printing, dip-coating, draw-down bar coating, chemical vapor deposition (CVD), plasma enhanced CVD (PECVD), combinations thereof, and the like.

The aqueous precursor solution may be applied to both sides of the glass-based article either simultaneously or in sequence, the latter preferably after the coating applied to a first side of the sheet is dried (step 120) to remove water from the coating, leaving behind a layer or film-forming coating comprising the organic binder and the first alkali metal salt and second alkali metal salt in solid form. Water is removed from the film-forming layer by drying in air, leaving behind the alkali metal salt and binder. In some embodiments, the film-forming layer is dried at room temperature (about 20° C. to about 30° C.)—preferably in a fume hood—for eight hours or more. In other embodiments, the film-forming layer is dried by heating at a temperature in a range from about 100° C. to about 140° C., or from about 100° C. to about 120° C., for a time period in a range from about 8 minutes to about 30 minutes, or from about 8 minutes to about 20 minutes, or from about 8 minutes to about 15 minutes. The binder is then removed by heating the film-forming layer and glass-based article at a temperature in a range from about 300° C. to about 500° C., or from about 300° C. to about 450° C., or from 300° C. to about 400° C., or from about 300° C. to about 370° C., or from about 300° C. to about 350° C., leaving behind a continuous or near-continuous layer of the solid first and second alkali metal salts in physical contact with the surface of the glass-based article.

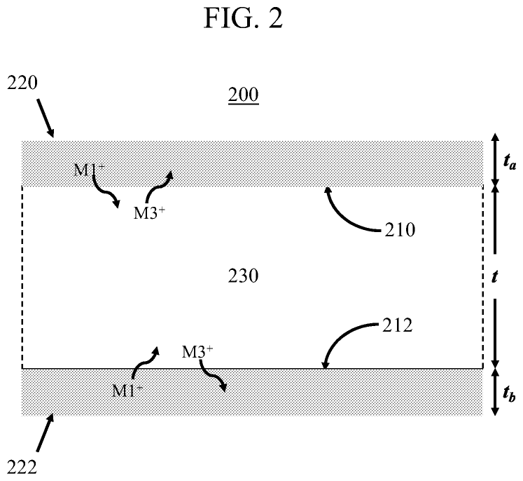

FIG. 2 is a schematic cross-sectional view of a glass-based article 200 having a film-forming layer 220 deposited on one surface. Glass-based article 230 has a first surface 210, second surface 212, and a thickness t in a range from about 20 to about 300 μm. In some embodiments, the glass thickness t is in a range from about 20 μm to about 200 μm; in some embodiments, from about 20 μm to about 100 μm; in some embodiments from about 20 μm to about 70 μm; in some embodiments from about 20 μm to about 50 μm; in some embodiments from about 20 μm to about 40 μm; and in some embodiments from about 20 μm to about 30 μm. Film-forming layer 220, which comprises the solid first and second alkali metal salts when dried, is deposited on surface 210 of glass-based article 200. In some embodiments, a second film-forming layer 222, which also comprises the first and second alkali metal salts when dried, is deposited on a second surface 212 opposite first surface 210 of glass-based article. Film-forming layers 220, 222, have thicknesses tₐ and t_{b}, respectively. Each of thicknesses tₐ and t_{b} is in a range from about 1 mm to about 2 mm; in some embodiments from about 1 mm to about 1.5 mm, and in other embodiments from about 0.5 mm to about 1.5 mm. In some embodiments, tₐ=t_{b} and in other embodiments tₐ≠t_{b} (i.e., tₐ<t_{b} or tₐ>t_{b}).

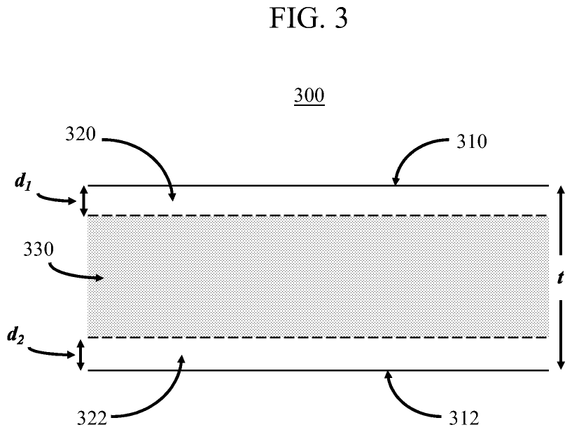

Once any organic binder has been removed from film-forming layers 220, 222, glass-based article 200 with film-forming layers 220, 222 is heated at a temperature in a range from about 350° C. to about 500° C., or from about 380° C. to about 420° C. or, in certain embodiments, in a range from about 390° C. to about 410° C. (step 130 in FIG. 1). At these temperatures, the first alkali metal salt in the film-forming layers 220, 222 is molten while the second alkali metal salt is solid. The combination of the solid second alkali metal salt and molten first alkali metal salt allows the film-forming layers 220, 222 to remain on—rather than flow or otherwise fall off—the major surfaces 210, 212 of the glass-based article 200. At this temperature, the first alkali cations in the first alkali metal salt melt (M1⁺ in FIG. 2) present in at least one film-forming layers 220, 222 replace—i.e., are exchanged or “ion exchanged”—for the third alkali cations in the glass-based article 230 (M3⁺ in FIG. 2), thereby forming a compressive stress layer (320, 322 in FIG. 3) extending from at least one surface (310, 312 in FIG. 3, wherein surfaces 310, 312 in FIG. 3 correspond to surfaces 210, 220 in FIG. 2) of the glass-based article to a depth of compression DOC (d₁, d₂ in FIG. 3). In some embodiments, the radius of the first alkali cation M1⁺ is greater than the radius of third alkali cation M3⁺ (for example, r(M1⁺)>r(M3⁺)). If, for example, M3⁺ is Li⁺, then M1⁺ may be Na⁺, K⁺, Rb⁺, or combinations thereof. In some embodiments, if M3⁺ is Li⁺, then M1⁺ may be Na⁺, K⁺, or both. If M3⁺ is Na⁺, then M1⁺ may be K⁺, Rb⁺, or both. The coated glass-based article 200 is ion exchanged at a temperature within the above temperature range for a time period ranging from about 10 minutes to about 30 minutes or, in some embodiments, from about 10 minutes to about 20 minutes. After ion exchange, the strengthened glass-based article may be allowed to cool to room temperature and any residue of film-forming layers 220, 222 or coatings remaining on surfaces 210, 212 may be removed (step 132 in FIG. 1) by rinsing with deionized water.

Method 100 may be carried out as either a batch or continuous process. An example of a continuous process is schematically shown in FIG. 1A. In continuous process 100a, an aqueous precursor solution 150 comprising an organic binder and one or more alkali metal salt is applied (step 110a) to a first surface of glass-based article 160 to form a film-forming layer 161 on the first surface. In the embodiment shown in FIG. 1A, aqueous precursor solution 150 is applied to the first surface by spray coating the solution through a spray nozzle 152. Following step 110a, the glass-based article 162 with first film-forming layer 161 is transported by a conveyance system 154a to a drying station, where the film-forming layer 161 is allowed to dry (step 120a) at about 100, in some embodiments, for about 30 minutes at about 100° C. for 30 minutes to remove water, and the organic binder is removed by heating the glass-based article with first film-forming layer 162 to a temperature in a range from about 300° C. to about 500° C., or from about 300° C. to about 450° C., or from 300° C. to about 400° C., or from about 300° C. to about 370° C., or from about 300° C. to about 350° C. to either decompose or evaporate the binder. In some embodiments, for example when AQUAZOL® is used as a binder, the glass-based article and film-forming layer 162 are heated to a temperature in a range from about 380° C. to about 400° C. to decompose the binder. The glass-based article with first film-forming layer 162 is then turned or flipped over (step 122) and a second film-forming layer 163 is applied to the second surface of glass-based article 162 opposite the first surface (step 110b). Step 110b may be identical to step 110a, as shown in FIG. 1A, or in some embodiments, may differ from step 110a. The glass-based article 164 with first and second film-forming layers 161, 163 is then allowed to dry to first remove water and the organic binder is then removed (step 120b). The glass-based article is moved by conveyance system 154b to a tunnel oven 163, where glass-based article 164 is heated and ion exchanged for a predetermined time and temperature to achieve the desired peak compressive stress CS and depth of compression DOC.

In some embodiments, methods 100, 100a may also be carried out as a batch process (not shown) in which a plurality of glass-based articles is simultaneously coated, dried and/or cured, and ion exchanged.

Method 100 described herein serves to minimize breakage of ultra-thin glass-based articles by reducing contact with the glass-based article or otherwise due to handling and/or immersion in a molten salt bath. In addition, the use of a thin layer of solid alkali metal salt rather than a molten salt bath potentially reduces the costs associated with ion exchange, and allows the concentration(s) of the alkali metal salt(s) in the aqueous precursor solution and the resulting coating(s) on the glass-based article to be readily adjusted.

A cross-sectional schematic view of an ion exchanged glass-based article 300 that has been strengthened according to the method 100 is shown in FIG. 3. Glass article 300 has a thickness t, first surface 310, and second surface 312, with the thickness t being, for example, in a range from about 20 μm to about 300 μm; in some embodiments from about 20 μm to about 200 μm; in some embodiments, from about 20 μm to about 125 μm; in some embodiments, from about 20 μm to about 100 μm; in some embodiments from about 20 μm to about 70 μm; in some embodiments from about 20 μm to about 50 μm; in some embodiments from about 20 μm to about 40 μm; and in some embodiments from about 20 μm to about 30 μm. The ion exchanged glass article 300 has a first compressive stress layer 320 extending from first surface 310 to a first DOC at depth di into the bulk of the glass-based article 300. In FIG. 3, ion exchanged glass-based article 300 also has a second compressive stress layer 322 extending from second surface 312 to a second DOC at depth d₂. The ion exchanged glass-based article 300 also has a central region 330 that extends from d₁ to d₂. Central region 330 is typically under a tensile stress or central tension (CT), which balances or counteracts the compressive stresses of compressive stress layers 320 and 322. The depths d₁, d₂ of first and second compressive layers 320, 322, respectively, protect the glass-based article 300 from the propagation of flaws introduced by sharp impact to first and second surfaces 310, 312 of ion exchanged glass-based article 300, while the compressive stress minimizes the likelihood of a flaw penetrating through the depths d₁, d₂ of first and second compressive layers 320, 322.

The high peak compressive stresses that may be achieved by ion exchange provide the capability to bend the glass to a tighter (i.e., smaller) bend radius for a given glass thickness. The high peak compressive stress allows the glass to retain net compression and thus contain surface flaws within the compressive stress layer when the ion exchanged glass-based article is subjected to bending around a tight radius (bend radius). Near-surface flaws cannot extend to failure if they are contained under this net compression or within the effective surface compressive stress layer.

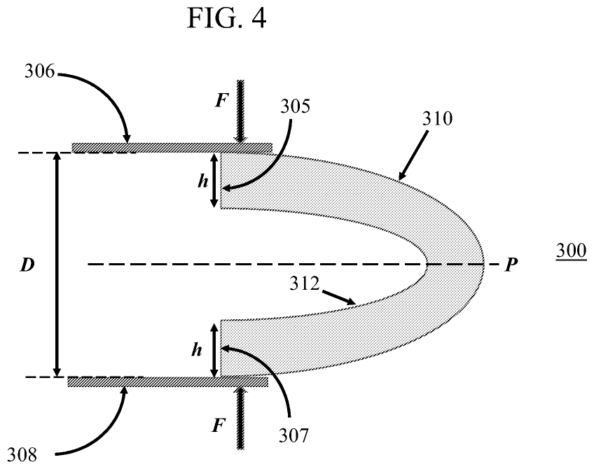

FIG. 4 is a schematic cross-sectional view of an ion exchanged glass-based article 300 strengthened by the method 100 that is under bend-induced stress. Force F is applied to bend the ion exchanged glass-based article 300 at midpoint P to a point where opposite ends 305, 307 of the glass-based article are parallel to each other. The ion exchanged glass-based article is elliptical in shape when bent by force F. Two parallel plates 306, 308 are used to determine the distance between opposite ends 305, 307 of the ion exchanged glass-based article 300, and the distance D between parallel plates 306, 308 is then converted to an elliptical bend radius. The bend radius R is given by the equation

R=(D−h)/2.396,

where h is the thickness of the ion exchanged glass-based article.

The outer surface 310 of the ion exchanged glass-based article 300 is subjected to a tensile stress from the bending. The tensile stress causes the DOC on the outer surface 310 to decrease to an effective DOC, while the inner surface 312 is subjected to additional compressive stress from the bending. The effective DOC on the outer surface 310 increases with increasingly tighter (or smaller) bend radii and decreases with decreasingly tight (or bigger) bend radii (when the center of curvature is on the side of the ion exchanged glass-based article opposite outer surface 310, as shown in FIG. 4).

The bend radius is affected by the thickness of the ion exchanged ion exchanged glass-based article—for example, the thicker the glass-based article, the greater the minimum bend radius. The bendable ion exchanged glass-based articles strengthened according to the method 100 and described herein having a thickness in a range from about 100 μm to about 35 μm, wherein minimum elliptical bend radii of each ion exchanged glass-based article is in a range from about 5 mm or 6 mm to 3 mm. The minimum elliptical bend radius for an ion exchanged bendable glass-based articles with a thickness of about 100 μm is about 6 mm. in some embodiments, the minimum elliptical bend radius is about 5 mm for ion exchanged bendable glass-based articles with a thickness of about 75 μm, whereas the minimum elliptical bend radius is about 4 mm ion exchanged bendable glass-based articles with a thickness of about 50 μm, and minimum elliptical bend radius is about 3 mm for ion exchanged bendable glass-based articles with a thickness of about 35 μm.

Because of the stress generated while bending, the thicker the glass, the higher the bend stress at the same bend radius. When bent to smaller radii, the stress is even greater on the thicker glass. Thus, the stress imparted by ion-exchange or other strengthening methods is used to combat the bending stress. For the ion exchanged glass-based articles having a thickness in the range from about 35 μm to 100 um, the peak compressive stress CS imparted to the glass-based articles by ion exchanged is in a range from about 600 MPa to about 900 MPa.

When ion exchanged, the glass-based articles with a thickness of about 125 μm that are strengthened according to the methods 100 and 100a and described herein can withstand a bend radius of about 5 mm (i.e., R=5 mm) for 240 hours at about 60° C. and 90% relative humidity without breaking.

In some embodiments, a bendable glass-based article that has been chemically strengthened by, for example, the ion exchange methods described herein, is provided. The glass-based article 200 and chemically strengthened bendable glass-based article 300, previously described hereinabove, may comprise an alkali-containing silicate glass such as, for example, a soda lime glass, the typical composition of which is 72 mol % SiO₂, 1% Al₂O₃, 14 mol % Na₂O, 4 mol % MgO, and 7 mol % CaO. In some embodiments, the strengthened bendable glass-based article 300 is chemically strengthened according to the method 100 previously described hereinabove.

In some embodiments, the chemically strengthened bendable glass-based articles described herein comprises an alkali aluminoborosilicate glass. The alkali aluminoborosilicate glass comprises: from about 50 to about 72 mol % SiO₂ (50 mol %≤SiO₂≤72 mol %); from about 9 mol % to about 17 mol % Al₂O₃ (9 mol %≤Al₂O₃≤17 mol %); from about 2 mol % to about 12 mol % B₂O₃ (2 mol %≤B₂O₃≤12 mol %); from about 8 mol % to about 16 mol % Na₂O (8 mol %≤Na₂O≤16 mol %); and from about 0 mol % to about 4 mol % K₂O (0 mol %≤K₂O≤4 mol %), wherein the ratio

[Al₂O₃(mol %)+B₂O₃(mol %)/Σmodifiers(mol %)]>1,

where the modifiers are selected from the group consisting of alkali metal oxides and alkaline earth metal oxides. This alkali aluminoborosilicate glass is described in U.S. Pat. No. 8,586,492 by Kristen L. Barefoot et al. entitled “Crack and Scratch Resistant Glass and Enclosures Made Therefrom,” having a priority date of Aug. 21, 2009, the contents of which are incorporated herein by reference in their entirety.

In some embodiments, the chemically strengthened glass-based articles described herein comprise an alkali aluminosilicate glass that comprises SiO₂ and Na₂O and has a temperature T³⁵kp at which the glass has a viscosity of 35 kpoise, wherein SiO₂+B₂O₃≥66 mol % and Na₂O≥9 mol %, and wherein the temperature T_{breakdown} at which zircon breaks down to form ZrO₂ and SiO₂ is greater than T³⁵kp. In some embodiments, the glass comprises: from about 61 mol % to about 75 mol % SiO₂ (61 mol %≤SiO₂≤75 mol %); from about 7 mol % to about 15 mol % Al₂O₃ (7 mol %≤Al₂O₃≤15 mol %); from 0 mol % to about 12 mol % B₂O₃ (0 mol %≤B₂O₃≤12 mol %); from about 9 mol % to about 21 mol % Na₂O (9 mol %≤Na₂O≤21 mol %); from 0 mol % to about 4 mol % K₂O (0 mol %≤K₂O≤4 mol %); from 0 mol % to about 7 mol % MgO (7 mol %≤MgO≤7 mol %); and from 0 mol % to about 3 mol % CaO (0 mol %≤CaO≤3 mol %). In some embodiments, the glass comprises: 69.1 mol % SiO₂; 10.1 mol % Al₂O₃; 15.1 mol % Na₂O; 0.01 mol % K₂O; 5.5 mol % MgO; 0.01 mol % Fe₂O₃; 0.01 mol % ZrO₂; and 0.13 mol % SnO₂. In some embodiments, the glass further comprises one or more of B₂O₃, K₂O, MgO, CaO, or combinations thereof. This alkali aluminoborosilicate glass is described in U.S. Pat. No. 8,802,581 by Matthew J. Dejneka et al., entitled “Zircon Compatible Glasses for Down Draw,” having a priority date of Aug. 21, 2009, the contents of which are incorporated herein by reference in their entirety.

In some embodiments, the chemically strengthened glass-based article described herein comprises an alkali aluminosilicate glass that comprises: about 58 mol % or more of SiO₂ (58 mol %≤SiO₂); from about 0.5 mol % to about 3 mol % P₂O₅ (0.5 mol %≤P₂O₅≤3 mol %); about 11 mol % or more of Al₂O₃ (11 mol %≤Al₂O₃); Na₂O; and Li₂O, wherein the molar ratio of Li₂O to Na₂O (Li₂O(mol %)/Na₂O(mol %)) is less than 1.0, and wherein the alkali aluminosilicate glass is free of B₂O₃. In some embodiments, the glass comprises: from about 58 mol % to about 65 mol % SiO₂ (58 mol %≤SiO₂≤65 mol %); from about 11 mol % to about 20 mol % Al₂O₃ (11 mol %≤Al₂O₃≤20 mol %); from about 0.5 mol % to about 3 mol % P₂O₅ (0.5 mol %≤P₂O₅≤3 mol %); from about 6 mol % to about 18 mol % Na₂O (6 mol %≤Na₂O≤18 mol %); from 0 mol % to about 6 mol % MgO (0 mol %≤MgO≤6 mol %); and from 0 mol % to about 6 mol % ZnO (0 mol %≤ZnO≤6 mol %). This alkali aluminosilicate glass is described in U.S. patent application Ser. No. 15/191,913 by Timothy M. Gross entitled “Glass with High Surface Strength,” having a priority date of Jun. 26, 2015, the contents of which are incorporated herein by reference in their entirety.

In some embodiments, the chemically strengthened glass-based articles described herein comprises an alkali aluminosilicate glass. The alkali aluminoborosilicate glass comprises: from about 60 mol % to about 70 mol % SiO₂ (60 mol %≤SiO₂≤70 mol %); from about 10 mol % to about 16 mol % Al₂O₃ (10 mol %≤Al₂O₃≤16 mol %); from about 2 mol % to about 10 mol % Li₂O (2 mol %≤Li₂O≤10 mol %); from about 8 mol % to about 13 mol % Na₂O (8 mol %≤Na₂O≤13 mol %); from greater than 0 mol % to about 6 mol % MgO (0 mol %<MgO≤6 mol %); and from about 2 mol % to about 6 mol % ZnO (2 mol %≤ZnO≤6 mol %). In some embodiments, the alkali aluminosilicate glass comprises: from about 62 mol % to about 68 mol % SiO₂ (62 mol %≤SiO₂≤68 mol %); from about 12 mol % to about 14 mol % Al₂O₃ (12 mol %≤Al₂O₃≤14 mol %); from about 2 mol % to about 6 mol % Li₂O (2 mol %≤Li₂O≤6 mol %); from about 8 mol % to about 13 mol % Na₂O (8 mol %≤Na₂O≤13 mol %); from greater than 0 mol % to about 3 mol % MgO (0 mol %<MgO≤3 mol %); and from about 2 mol % to about 5 mol % ZnO (2 mol %≤ZnO≤5 mol %). In some embodiments, Li₂O(mol %)/R₂O(mol %)≥0.2, in other embodiments, Li₂O(mol %)/R₂O(mol %)≤0.95, in yet other embodiments Li₂O(mol %)/R₂O(mol %)≤0.90, and, in still other embodiments, Li₂O(mol %)/R₂O(mol %)≤0.50, where R₂O=Li₂O+Na₂O+K₂O+Rb₂O+Cs₂O. The alkali metal oxides K₂O, Rb₂O, and Cs₂O may not necessarily be included in the glass; the addition of these oxides is thus optional. This alkali aluminosilicate glass is described in WIPO Publication No. WO 2017/151771, entitled “Glass with High Surface Strength,” claiming priority from U.S. Provisional Patent Application No. No. 62/303,671 filed on Mar. 4, 2016, the contents of which are incorporated herein by reference in their entirety.

In some embodiments, the chemically strengthened glass-based articles described herein comprises an alkali aluminosilicate glass comprising: about 17 mol % or more of Al₂O₃ and non-zero amounts of Na₂O, MgO, and CaO, wherein Al₂O₃(mol %)+RO(mol %)≥21 mol %, where RO(mol %)=MgO(mol %)+CaO(mol %)+ZnO(mol %). The alkali aluminosilicate glass is substantially free of SrO, BaO, B₂O₃, P₂O₅, and K₂O. In some embodiments, the glass comprises: from about 52 mol % to about 61 mol % SiO₂ (52 mol %≤SiO₂≤61 mol %); from about 17 mol % to about 23 mol % Al₂O₃ (17 mol %≤Al₂O₃≤23 mol %); from 0 mol % to about 7 mol % Li₂O (0 mol %≤Li₂O≤7 mol %); from about 9 mol % to about 20 mol % Na₂O (9 mol %≤Na₂O≤20 mol %); from greater than 0 mol % to about 5 mol % MgO (0 mol %<MgO≤5 mol %); from greater than 0 mol % to about 5 mol % CaO (0 mol %<CaO≤5 mol %); and from greater than 0 mol % to about 2 mol % ZnO (0 mol %<ZnO≤2 mol %). In some embodiments, the glass comprises: from about 55 mol % to about 61 mol % SiO₂ (55 mol %≤SiO₂≤61 mol %); from about 17 mol % to about 20 mol % Al₂O₃ (17 mol %≤Al₂O₃≤20 mol %); from 4 mol % to about 7 mol % Li₂O (4 mol %≤Li₂O≤7 mol %); from about 9 mol % to about 15 mol % Na₂O (9 mol %≤Na₂O≤15 mol %); from greater than 0 mol % to about 5 mol % MgO (0 mol %<MgO≤5 mol %); from greater than 0 mol % to about 5 mol % CaO (0 mol %<CaO≤5 mol %); and from greater than 0 mol % to about 2 mol % ZnO (0 mol %<ZnO≤2 mol %). This alkali aluminosilicate glass is described in U.S. Provisional Patent Application No. No. 62/714,404 by Timothy M. Gross, filed Aug. 3, 2018, the contents of which are incorporated herein by reference in their entirety.

Glass-based articles having the glass compositions described hereinabove are initially formable by processes that include, but are not limited to, fusion draw, overflow, rolling, slot draw, redrawing, float processes, or the like. These glasses have a liquidus viscosity in a range from about 5 kP to about 200 kP and, in some embodiments, in a range from about 30 kP or 70 kP to about 150 kP. To obtain an “ultra-thin” bendable glass-based article (for example, having a thickness of less than about 100 μm), the glass-based article may be re-drawn to the desired thickness. Sheet thicknesses ranging from about 100 μm to about 70 μm or to about 50 μm are achievable using those etching means know in the art. By adjusting etching time and etching solution concentration, a desired final thickness can be reached. A 130 μm thick glass-based article, for example, may be etched to obtain a final thickness of ranging from about 100 μm to about 70 μm, or to about 50 μm, or to about 25 μm, or to about 20 μm, using an etching solution comprising about 15 vol % HF and about 15 vol % HCl, which may produce an etching rate of about 1.1 μm per minute.

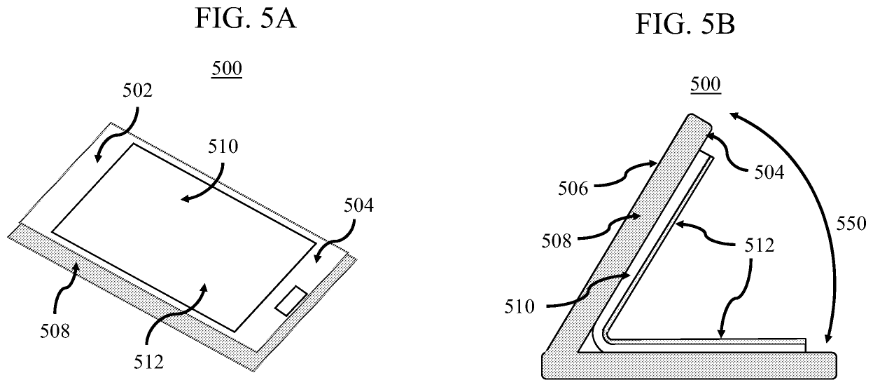

In some embodiments, the chemically strengthened bendable glass-based articles 300 or articles described herein may serve as at least a portion of an electronic device having a foldable feature that includes for example, but is not limited to, a display, a printed circuit board, or other features associated with a foldable electronic device. In particular embodiments, the chemically strengthened bendable glass article forms at least a portion of a wearable electronic device, for example, a watch, wallet, bracelet, or the like. In those instances where the chemically strengthened bendable glass-based article or article forms at least a portion of a display, the strengthened bendable glass article may be substantially transparent and may further have a pencil hardness of 8 H or more and also have the bend radius capabilities described hereinabove. An exemplary article incorporating the bendable strengthened bendable glass-based article 300 disclosed herein is shown in FIGS. 5A and 5B. Specifically, FIGS. 5A and 5B show a consumer electronic device 500 that includes: a housing 502 having front 504, back 506, and side surfaces 508; electrical components (not shown) that are at least partially inside or entirely within the housing 502 and including a controller, a memory, a display 510 at or adjacent to the front surface 504 of the housing 502; and a cover substrate 512 at or over the front surface of the housing such that it is over the display. In some embodiments, at least one of the cover substrate 512 or a portion of housing 502 may include any of the chemically strengthened bendable glass-based article 300 or article disclosed herein. The consumer electronic article 500 is flexible: when subjected to a bending force (550 in FIG. 5B) the flexible electronic device 500 and the chemically strengthened bendable glass-based article 300 are able to bend to a given bend radius (not shown) without failure.

### EXAMPLES

The following examples illustrate the features and advantages provided by the processes and articles described herein and are in no way intended to limit this disclosure thereto.

### Example 1

A potassium source for chemical strengthening is first prepared. In one embodiment, the potassium source an aqueous precursor solution containing K₃PO₄ and KNO₃ in a molar ratio of 9:1. The aqueous precursor solution comprises 25% of these two alkali metal salts by weight. The aqueous precursor solution also contains from about 1.2% to about 1.4% by weight of an organic binder—in this case ethylene acrylic acid (EAA). The aqueous precursor solution is applied to a first surface of the ultra-thin glass-based article using an air actuated spray valve. The coating applied to the first surface is allowed to dry, in some embodiments, for about 30 minutes at about 100° C. to remove water, in some embodiments, thereby removing the aqueous solvent, leaving a coating comprising the organic binder, solid K₃PO₄, and solid KNO₃ on the first surface. In some embodiments, the coated surface is dried under ambient conditions such as, for example, at about 20-30° C. for 8 hours or more in air or in a fume hood. In some embodiments, a second surface opposite the first surface is then spray-coated with the aqueous precursor solution and allowed to dry, in some embodiments, for about 30 minutes at about 100° C. to remove water, leaving a coating comprising the organic binder and solid K₃PO₄ (melting point 1380° C.) and KNO₃ (melting point 334° C.) on the second surface. The organic binder is burned out or otherwise removed at a temperature ranging from about 300° C. to about 500° C., or from about 425° C. to about 500° C., leaving behind K₃PO₄ in solid form and a KNO₃ melt. Both solid and liquid alkali metal salts are in physical contact with the surface of the glass-based article. The glass-based article and coating are then heated at a temperature in a range from about 350° C. to about 500° C., or from about 380° C. to about 420° C., or from about 390° C. to about 410° C. at which point KNO₃ cations in the melt migrate into the glass-based article and replace Li⁺ and/or Na⁺ cations in the glass-based article, thereby achieving a desired peak compressive stress (CS) and depth of compression (DOC). In some embodiments, alkali aluminosilicate glass-based articles having a thickness of about 100 μm may be ion exchanged according to the methods described herein in order to achieve a peak compressive stress in a range from about 750 MPa to about 850 MPa or in other embodiments, from about 400 MPa to about 700 MPa, and a depth of compression in a range from about 9 μm to about 15 μm and, in other embodiments, from about 12 μm to about 15 μm.

Results of ion exchange studies performed on 100 μm thick ultra-thin alkali aluminosilicate glass-based articles are listed in Table 1. Each of the glass-based articles was strengthened according to the methods described herein and had a nominal composition of 69.1 mol % SiO₂; 10.1 mol % Al₂O₃; 15.1 mol % Na₂O; 0.01 mol % K₂O; 5.5 mol % MgO; 0.01 mol % Fe₂O₃; 0.01 ZrO₂; and 0.13 mol % SnO₂, which is described in U.S. Pat. No. 8,802,581, previously cited herein. The two major surfaces (for example, not the edges) of each glass-based article were spray-coated with an aqueous precursor solution containing K₃PO₄ and KNO₃ in a molar ratio of 9:1 and were allowed to dry overnight (for example, for about 8 to 12 hours) at room temperature (for example, about 20° C. to about 30° C.) in air, leaving a coating on the surface of the glass-based article. The coated samples then ion exchanged by heating them at temperatures ranging from about 390° C. to about 410° C. for time periods ranging from about 30 minutes to about 60 minutes. Results of the ion exchange experiments are listed in Table 1 below.

TABLE 1
Results of ion exchange experiments preformed on alkali aluminosilicate
glass-based articles, each having a thickness of 100 μm.

| | Ion exchange | Ion exchange | CS | DOC |
|---|---|---|---|---|
| Sample | temperature | time | (MPa) | (μm) |
| 1 | 390° C. | 30 minutes | 668.98 | 9.01 |
| 2 | 390° C. | 60 minutes | 577.7 | 12.14 |
| 3 | 410° C. | 30 minutes | 450.96 | 12.98 |

While typical embodiments have been set forth for the purpose of illustration, the foregoing description should not be deemed to be a limitation on the scope of the disclosure or appended claims. Accordingly, various modifications, adaptations, and alternatives may occur to one skilled in the art without departing from the spirit and scope of the present disclosure or appended claims.

1. A method of chemically strengthening a glass-based article, the method comprising:
a. applying an aqueous precursor solution comprising an organic binder, a first alkali metal salt comprising a plurality of first alkali metal cations, and a second alkali metal salt comprising a plurality of second alkali metal cations to a surface of the glass-based article to form a first coating on the surface, the first coating comprising the organic binder and the first alkali metal salt and the second alkali metal salt, wherein the aqueous precursor solution is applied to the surface at room temperature;
b. removing the organic binder to form a second coating comprising the first alkali metal salt and the second alkali metal salt in solid form; and
c. heating the glass-based article and the second coating at a temperature in a first range from about 350° C. to about 500° C. to form a melt from the first alkali metal and to replace third alkali metal cations in the glass-based article with the first alkali metal cations to form a chemically strengthened glass-based article, the chemically strengthened glass-based article comprising a compressive stress layer extending from the surface of the glass-based article to a depth of compression in a range from about 5 μm to about 60 μm.

2. The method of claim 1, wherein the thickness of the glass-based article before and after chemical strengthening is in a range from about 20 μm to about 300 μm.

3. The method of claim 1, wherein the compressive stress layer comprises a maximum compressive stress in a range from about 300 MPa to about 2000 MPa.

4. The method of claim 1, wherein each of the first alkali metal salt and the second alkali metal salt comprises one or more of a nitrate, a sulfate, a phosphate, a carbonate, a halide, or combinations thereof.

5. The method of claim 1, wherein the first alkali cation and the second alkali cation are the same.

6. The method of claim 1, wherein the first alkali metal salt is KNO₃ and the second alkali metal salt is K₃PO₄.

7. The method of claim 1, wherein the third alkali metal cation is one or more of Li⁺, Na⁺, or combinations thereof.

8. The method of claim 1, wherein the first alkali cation has a first ionic radius and the third alkali metal cation has a third ionic radius, and wherein the first ionic radius is greater than the third ionic radius.

9. The method of claim 1, wherein the glass-based article comprises an alkali aluminosilicate glass, an alkali aluminoborosilicate glass, an alkali borosilicate glass, or a soda lime glass, and wherein the alkali aluminoborosilicate or alkali aluminosilicate glass comprises:
a. from about 50 mol % to about 72 mol % SiO₂; from about 9 mol % to about 17 mol % Al₂O₃; from about 2 mol % to about 12 mol % B₂O₃; from about 8 mol % to about 16 mol % Na₂O; and from 0 mol % to about 4 mol % K₂O, wherein the ratio [Al₂O₃(mol %)+B₂O₃(mol %)/Σmodifiers(mol %)]>1, where the modifiers are selected from the group consisting of alkali metal oxides and alkaline earth metal oxides; or
b. from about 61 mol % to about 75 mol % SiO₂; from about 7 mol % to about 15 mol % Al₂O₃; from 0 mol % to about 12 mol % B₂O₃; from about 9 mol % to about 21 mol % Na₂O; from 0 mol % to about 4 mol % K₂O; from 0 mol % to about 7 mol % MgO; and from 0 mol % to about 3 mol % CaO; or
c. about 58 mol % or more of SiO₂; from about 0.5 mol % to about 3 mol % P₂O₅; about 11 mol % or more of Al₂O₃; Na₂O; and Li₂O, wherein the molar ratio (Li₂O/Na₂O) is less than 1.0, and wherein the alkali aluminosilicate glass article is free of B₂O₃; or
d. from about 60 mol % to about 70 mol % SiO₂; from about 10 mol % to about 16 mol % Al₂O₃; from about 2 mol % to about 10 mol % Li₂O; from about 8 mol % to about 13 mol % Na₂O; from greater than 0 mol % to about 6 mol % MgO; and from about 2 mol % to about 6 mol % ZnO; or
e. about 17 or more mol % Al₂O₃ and non-zero amounts of Na₂O, MgO, and CaO, wherein Al₂O₃(mol %)+RO(mol %)≥21 mol %, where RO(mol %)=MgO(mol %)+CaO(mol %)+ZnO(mol %), and wherein the alkali aluminosilicate glass is substantially free of each of SrO, BaO, B₂O₃, P₂O₅, and K₂O.

10. The method of claim 1, wherein the step of applying the aqueous precursor solution to the surface of the glass-based article to form the first coating comprises one or more of spraying the aqueous precursor solution onto the surface, dipping the glass-based article in the aqueous precursor solution, or casting the aqueous precursor solution on the surface.

11. The method of claim 1, wherein the step of removing the organic binder comprises heating the glass-based article and the first coating at a temperature in a second range from about 300° to about 500° C.

12. The method of claim 1, wherein the step of heating the glass-based article and the second coating at a temperature in the first range from about 350° C. to about 500° C. comprises heating the glass-based article and the second coating at the temperature for a predetermined time period in a range from about 10 minutes to about 20 minutes.

13. The method of claim 1, wherein the thickness of the glass-based article after chemical strengthening is in a range from about 100 μm to about 35 μm and comprises a minimum bend radius in a range from about 3 mm to about 6 mm or from about 3 mm to about 5 mm.

14. The method of claim 1, wherein the organic binder comprises one or more of a surfactant, a rheological modifier, or combinations thereof.

15. The method of claim 1, wherein the organic binder comprises one or more of cellulose, at least one cellulose derivative, at least one hydrophobically modified ethylene oxide urethane modifier, ethylene acrylic acid, or combinations thereof.

16. A chemically strengthened bendable glass-based article comprising: a thickness in a range from about 35 μm to about 100 μm; an alkali aluminosilicate glass, an alkali borosilicate glass, or a soda lime glass; a compressive stress layer extending from a first surface of the article to a depth of compression from about 5 μm to about 60 μm, and wherein the compressive stress layer comprises a maximum compressive stress in a range from about 600 MPa to about 900 MPa; wherein the depth of compression is in a range from about 5 μm to about 10 μm; and
wherein the chemically strengthened glass-based article comprises a minimum bend radius in a range from about 3 mm to about 6 mm.

17. The chemically strengthened bendable glass-based article of claim 16, wherein the alkali aluminoborosilicate or alkali aluminosilicate glass comprises:
a. from about 50 mol % to about 72 mol % SiO₂; from about 9 mol % to about 17 mol % Al₂O₃; from about 2 mol % to about 12 mol % B₂O₃; from about 8 mol % to about 16 mol % Na₂O; and from 0 mol % to about 4 mol % K₂O, wherein the ratio [Al₂O₃(mol %)+B₂O₃(mol %)/Σmodifiers(mol %)]>1, where the modifiers are selected from the group consisting of alkali metal oxides and alkaline earth metal oxides; or
b. from about 61 mol % to about 75 mol % SiO₂; from about 7 mol % to about 15 mol % Al₂O₃; from 0 mol % to about 12 mol % B₂O₃; from about 9 mol % to about 21 mol % Na₂O; from 0 mol % to about 4 mol % K₂O; from 0 mol % to about 7 mol % MgO; and from 0 mol % to about 3 mol % CaO; or
c. about 58 mol % or more SiO₂; from about 0.5 mol % to about 3 mol % P₂O₅; about 11 mol % or more Al₂O₃; Na₂O; and Li₂O, wherein the molar ratio (Li₂O/Na₂O) is less than 1.0, and wherein the alkali aluminosilicate glass is free of B₂O₃; or
d. from about 60 mol % to about 70 mol % SiO₂; from about 10 mol % to about 16 mol % Al₂O₃; from about 2 mol % to about 10 mol % Li₂O; from about 8 mol % to about 13 mol % Na₂O; from greater than 0 mol % to about 6 mol % MgO; and from about 2 mol % to about 6 mol % ZnO; or
e. about 17 or more mol % Al₂O₃ and non-zero amounts of Na₂O, MgO, and CaO, wherein Al₂O₃(mol %)+RO(mol %)≥21 mol %, where RO(mol %)=MgO(mol %)+CaO(mol %)+ZnO(mol %), and wherein the alkali aluminosilicate glass is substantially free of each SrO, BaO, B₂O₃, P₂O₅, and K₂O.

18. An electronic device comprising the chemically strengthened bendable glass-based article of claim 16, the electronic device comprising a housing comprising front, back, and side surfaces, electrical components which are at least partially internal to the housing, a display at or adjacent to the front surface of the housing, and a cover glass over the display, wherein one or more of the cover glass and the housing comprise the chemically strengthened bendable glass-based article, wherein the cover glass is at or over the front surface of the housing such that the cover glass is positioned over the display and protects the display from damage caused by impact.
